(19) United States
(12) Patent Application Publication
(10) Pub. No.: US 2014/0191731 A1
(43) Pub. Date: Jul. 10, 2014

(54) METHOD FOR CHARGING LITHIUM ION SECONDARY BATTERY

(71) Applicant: Kazutoshi Miura, Ibaraki-shi (JP)

(72) Inventor: Kazutoshi Miura, Ibaraki-shi (JP)

(73) Assignee: HITACHI MAXELL, LTD., Ibaraki-shi, Osaka (JP)

(21) Appl. No.: 13/821,497

(22) PCT Filed: Sep. 4, 2012
(86) PCT No.: PCT/JP2012/072451

§ 371 Date: Mar. 7, 2013

(30) Foreign Application Priority Data
Sep. 27, 2011 (JP) 2011-210931

(51) Int. Cl. H02J 7/00

(52) U.S. Cl. CPC H02J 7/0052
USPC 320/157

(57) ABSTRACT

CCCV charging is applied to a lithium ion secondary battery. During CC charging, a transition point Tₐ appears in temperature rise gradient when battery temperature rises along with the charging, and with the transition point Tₐ being a border, a temperature rise gradient in an initial T1 period is steeper than a temperature rise gradient in a T2 period following the T1 period. Based on charging time t_{T} corresponding to timing at which the transition point Tₐ appears after start of the CC charging from a condition of the SOC of 0%, changeover time tₛ is set in a range of t_{T}≦tₛ≦(t_{T}×1.2). The CC charging is performed at a first current value until changeover time t_{S} elapses after its start, and after the changeover time tₛ elapses, the CC charging is performed with a second current value larger than the first current value.

### TECHNICAL FIELD

The present invention relates to a charging method suitable for a lithium ion secondary battery configured through use of a negative electrode material containing silicon (Si).

### BACKGROUND ART

A lithium ion secondary battery is one of non-aqueous electrolyte secondary batteries, and has been used widely for its high voltage and high capacity, and a charging method thereof also has been improved variously so that the lithium ion secondary battery can be used more effectively. As a method for charging a lithium ion secondary battery, constant current constant voltage (CCCV) charging generally is used.

The CCCV charging is performed as shown in FIG. 6. In this figure, the horizontal axis represents time and the vertical axis represents voltage, current, and temperature. This figure shows the changes in voltage and temperature when the charging is performed with current being controlled as shown. In an initial charging period, first, constant current (CC) charging is performed. That is, assuming that a current value at which a fully charged battery can be discharged within one hour is 1C, for example, the charging is performed at a constant current of about 0.7 to 1C. The CC charging is continued until the voltage rises along with the charging to reach a predetermined set voltage Vc, for example, 4.2 V. When the voltage reaches the set voltage V_{c}, the CC charging is switched to constant voltage (CV) charging, and the charging is performed with the charging current being reduced so as to keep the set voltage V_{c}.

In recent years, in order to accomplish the charging in a short period of time, in the CCCV charging, there is a demand for maximizing the current during the CC charging. A charging amount is a value obtained by multiplying the charging current by the period of time, and hence, a procedure for performing the charging with an increased charging current is effective. However, heat generation is involved in charging, and an amount of the generated heat is increased along with an increase in current.

On the other hand, when a secondary battery is charged in a high-temperature environment, there is concern about the degradation of the secondary battery and the decrease in safety thereof. As a solution for avoiding excess temperature rise, for example, it has been known to incorporate a function of suspending the charging when the secondary battery reaches a predetermined temperature during the charging, into a circuit for charting the secondary battery. The temperature of the secondary battery is detected by a temperature detecting device (for example, a thermister) attached to the secondary battery or mounted on a protection circuit included in the secondary battery, and electrically transmitted to an external charger or an equipment with a battery pack mounted thereon.

FIG. 7 shows a process of charging in the above-mentioned configuration. Similarly to FIG. 6, the horizontal axis represents time, and the vertical axis represents voltage, current, and temperature. In a process of the CC charging from a start of the charging, when the temperature reaches the charging suspension temperature T_{off}, the charging is suspended. As described above, when the CC charging is performed at large current for completing the charging within a short period of time, the heat generation of a secondary battery is large, and hence, there is a high possibility that the temperature may reach the charging suspension temperature T_{off} during the charging to suspend the charging.

As shown in FIG. 7, there also is a case where a function is provided so as to resume the charging when after the charging is suspended (i.e., charging suspension period), the temperature of a battery pack drops to reach a charge resumption temperature Tₒₙ. In this case, the CC charging and the charging suspension are repeated similarly. After that, when the voltage reaches the set voltage V_{c}, the CC charging is switched to the CV charging.

When the charging is suspended due to the excess rise in temperature, there is a possibility that the charging may be completed while the battery has not been charged to a predetermined charge amount, or the total charging time to complete the charging may be extended.

Further, in order to prevent the temperature from reaching the charging suspension temperature T_{off}, a charging method for controlling as shown in FIG. 8 also has been known. That is, in an initial period of CC-a charging, the charging is performed with a relatively large charging current Iₐ. When the temperature of a battery pack rises to reach the changeover temperature T_{cc} set to be lower than the charging suspension temperature T_{off}, the CC-b charging is performed in which the charging current is reduced to Ib (Ib<Ia). Thus, by suppressing the charging current before the temperature of the battery pack reaches the charging suspension temperature T_{off}, the heat generation of the battery is suppressed to continue the charging while avoiding charging suspension. However, since the charging current is suppressed during the CC-b charging, the total charging time in the CC region is extended. Further, since the charging current at a time when the CV charging is started drops from large current for completing the charging within a short period of time, the charging time after the CV charging is started also increases.

Patent Document 1 discloses an example of a method for subjecting a lithium iron secondary battery to the CCCV charging, the method involving changing the charging current while monitoring the heat generation of a battery pack, as described above. That is, in a first charging step, a temperature rise gradient of a battery with respect to the charging current is detected, and the temperature of the battery, having been charged to a first set capacity, is predicted based on the detected temperature rise gradient. The battery is charged to the first set capacity with the charging current being controlled so that the battery temperature does not exceed the set temperature, based on the predicted temperature. In a second charging step, after the battery is charged to the first set capacity, the temperature of the battery, having been charged to a second set capacity, is predicted based on the temperature rise gradient. The battery is charged to the second set capacity with the charging current being controlled so that the battery temperature does not exceed the set temperature because of the predicted temperature. Accordingly, the lithium ion secondary battery can be fully charged in a short period of time while the temperature rise of the battery is prevented.

### PRIOR ART DOCUMENTS

### Patent Documents

Patent Document 1: JP 2009-148046 A

Patent Document 2: JP 2007-242590 A

### DISCLOSURE OF INVENTION

### Problem to be Solved by the Invention

According to the charging method disclosed by Patent Document 1, the current is changed in multiple stages while monitoring the heat generation gradient constantly, and hence, it is difficult to sufficiently accomplish the quick charging. Further, when such a method is used, time during which a secondary battery is exposed to a high-temperature state increases although the secondary battery does not reach high temperature to be avoided. Therefore, there is increased concern about the degradation of the secondary battery and the decrease in safety thereof.

On the other hand, a composite material (SiOₓ) having a structure in which Si ultra-fine particles are dispersed in SiO₂ has been known as a high-capacity negative electrode material for increasing the capacity of a secondary battery (for example, Patent Document 2). The inventors of the present invention discovered, as a novel finding, that the heat generation characteristics involved in the charging of a lithium ion secondary battery using a negative electrode material containing Si are not found in any other kinds of lithium ion secondary batteries, in a process of researching a charging method preferable for the above-mentioned lithium ion secondary battery. Then, the inventors of the present invention found that the problems in the above-mentioned conventional charging methods can be solved based on the heat generation characteristics.

Thus, it is an object of the present invention to provide a charging method enabling a lithium ion secondary battery using a negative electrode material containing Si to be charged at high efficiency while the heat generation during the charging is suppressed.

### Means for Solving Problem

A method for charging a lithium ion secondary battery of the present invention is a method for charging a lithium ion secondary battery by constant current constant voltage (CCCV) charging, including: a step of performing constant current (CC) charging up to a predetermined set voltage; and a step of switching the CC charging to constant voltage (CV) charging after the set voltage is reached, thus performing charging while reducing charging current so as to keep the set voltage.

The lithium ion secondary battery to which the charging method of the present invention is to be applied is composed using a negative electrode material containing Si, thereby having characteristics such that, during a period of the CC charging, a transition point Tₐ appears in a temperature rise gradient when temperature of the battery rises along with progression of the charging, and with the transition point Tₐ being a border, the temperature rise gradient in an initial T1 period is steeper than the temperature rise gradient in a T2 period following the T1 period.

A first charging method of a lithium ion secondary battery of the present invention has the feature that changeover time tₛ is set in a range of t_{T}≦tₛ≦(t_{T}×1.2), based on charging time t_{T} corresponding to timing at which the transition point Tₐ appears after start of the CC charging from a condition of the SOC (state of charge) of 0%, obtained by measurement in advance, and during a period of the CC charging, the CC charging is performed at a first current value until the changeover time tₛ elapses after start of the charging, and after the changeover time tₛ elapses, the CC charging is performed at a second current value larger than the first current value.

Further, a second method for charging a lithium ion secondary battery of the present invention has the feature that changeover time tₛ set in a range of t_{T}≦tₛ≦(t_{T}×1.2), based on charging time t_{T} corresponding to timing at which the transition point Tₐ appears after start of the CC charging from a condition of the SOC of 0%, obtained by measurement in advance, a charge state of the lithium ion secondary battery is determined before start of the charging, and during a period of the CC charging, when the charge state is before the transition point Tₐ, the CC charging is performed at a first current value until the changeover time tₛ elapses from start of the charging, and after the changeover time tₛ elapses, the CC charging is performed at a second current value larger than the first current value, and when the charge state exceeds the transition point Tₐ, the CC charging is performed at a second current value larger than the first current value.

### Effects of the Invention

According to the charging method of the above-mentioned configuration, during a period of the CC charging, the charging at a first current value is switched to the charging at a second current value larger than the first current value at changeover time that is set so as to correspond to a transition point of a temperature rise gradient involved in the charging. Thus, the charging is performed at smaller current during a period corresponding to a T1 period having a steep temperature rise gradient, and the charging is performed at larger current during a period corresponding to a T2 period having a gentle temperature rise gradient. Consequently, the heat generation in the period of a steep temperature rise gradient is suppressed to minimize temperature rise, while the charging can be performed efficiently during the period of a gentle temperature rise gradient, thereby shortening time required for charging.

Further, the CC charging can be performed up to the SOC exceeding 80% by suppressing heat generation, and hence, the time required for the charging can be shortened remarkably.

### BRIEF DESCRIPTION OF DRAWINGS

FIG. 1 is a graph showing characteristics to be a basis for a charging method of the present invention, which is peculiar to a lithium iron secondary battery using a negative electrode material containing Si ultra-fine particles.

FIG. 2 is a graph showing a method for charging a lithium ion secondary battery according to Embodiment 1.

FIG. 3 is a flowchart showing steps of the charging method.

FIG. 4 is a graph showing characteristics of a lithium ion secondary battery to which the same charging method cannot be applied.

FIG. 5 is a flowchart showing steps of a method for charging a lithium ion secondary battery according to Embodiment 3.

FIG. 6 is a graph showing an example of conventionally general constant current constant voltage (CCCV) charging.

FIG. 7 is a graph showing an example of improved conventional CCCV charging.

FIG. 8 is a graph showing an example of another improved conventional CCCV charging.

### DESCRIPTION OF THE INVENTION

The method for charging a lithium ion secondary battery of the present invention can take the following forms based on the above-mentioned configuration.

That is, in the second charging method, it is possible that the SOC of the lithium ion secondary battery is measured before starting the charging, and when the SOC is 10% or less, it is determined that the charge state is before the transition point Tₐ, and when the SOC exceeds 10%, it is determined that the charge state exceeds the transition point Tₐ.

Further, in the first or second charging method, the charging time t_{T} can be defined as charging time t_{T10} that elapses from a start of the charging at a condition of the SOC of 0% to time when the SOC reaches 10%, and changeover time tₛ₁ representing the changeover time tₛ can be set in a range of t_{T10}≦tₛ₁≦(t_{T10}×1.2).

Alternatively, the charging time t_{T} can be defined as a charging time t_{TA} that elapses from a start of the charging at a condition of the SOC of 0% to time when the transition point of a temperature rise gradient is detected, and changeover time tₛ₂ representing the changeover time tₛ can be set in a range of t_{TA}≦tₛ₂≦(t_{TA}×1.2).

Further, when 1C is defined as a current value at which the lithium ion secondary battery that is fully charged is discharged within one hour, the first current value can be set in a range of 0.7 to 0.8C.

Further, the second current value can be set to 1.5C or more.

Further, the SOC at completion of the T2 period can be set so as to exceed 80%.

Further, the lithium ion secondary battery can be composed by using a composite material (SiOₓ) having a structure in which ultra-fine particles of Si are dispersed in SiO₂ as the negative electrode material. In this case, the composite material (SiOₓ) can be formed of a core containing a material in which an atomic ratio x of oxygen with respect to silicon is 0.5≦x≦1.5, and a covering layer of carbon covering a surface of the core.

<Description of Characteristics to be a Basis of the Present Invention>

The charging method of the present invention is directed to a lithium ion secondary battery (hereinafter, referred to as “Si-containing lithium ion secondary battery”) using a negative electrode material containing Si such as a composite material (SiOₓ) having a structure in which Si ultra-fine particles are dispersed in SiO₂, and exhibits peculiar characteristics when charging the secondary battery. Therefore, in the description of this section, prior to the description of embodiments, the peculiar characteristics to be a basis of the present invention are described regarding a Si-containing lithium ion secondary battery.

The Si-containing lithium ion secondary battery can be charged and discharged smoothly to have high capacity due to the use of a high-capacity negative electrode material made of the above-mentioned composite material. As an example of a specific configuration of the Si-containing lithium ion secondary battery to which the present invention is directed, there is a non-aqueous secondary battery including a positive electrode, a negative electrode, and a non-aqueous electrolyte, as follows. The positive electrode includes a positive electrode mixture layer containing a lithium-containing transition metal oxide. The negative electrode includes a negative electrode mixture layer containing a negative electrode material formed of a core that contains a material containing silicon and oxygen as constituent elements in which an atomic ratio x of oxygen with respect to silicon is 0.5≦x≦1.5 and a covering layer of carbon covering the surface of the core. See Patent Document 2.

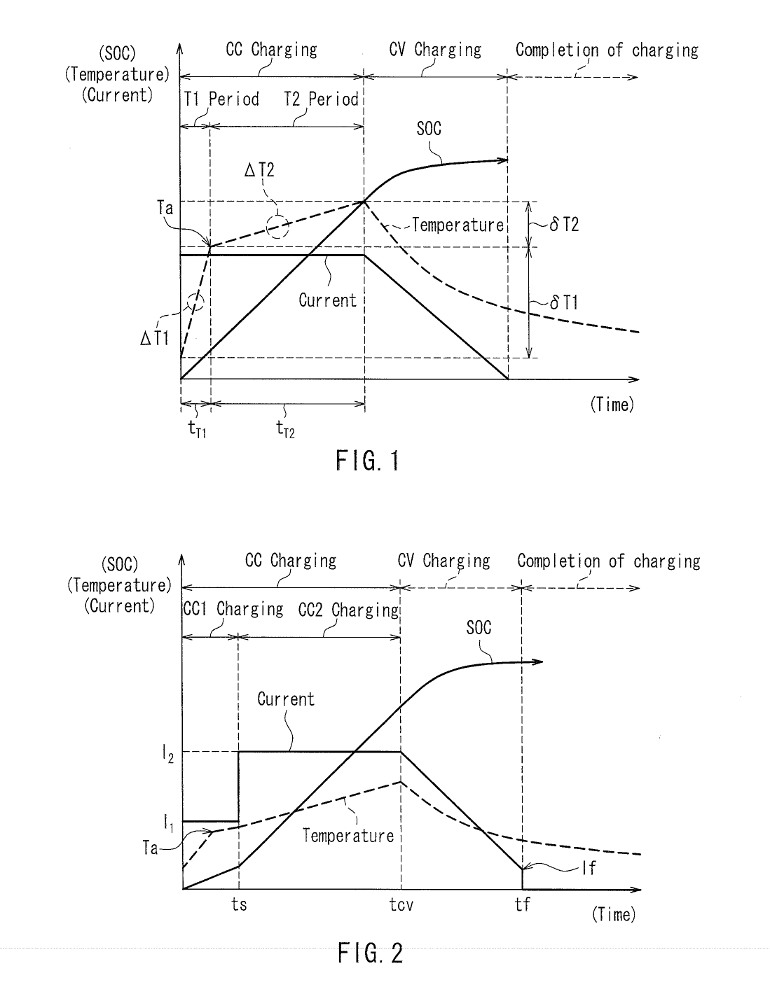

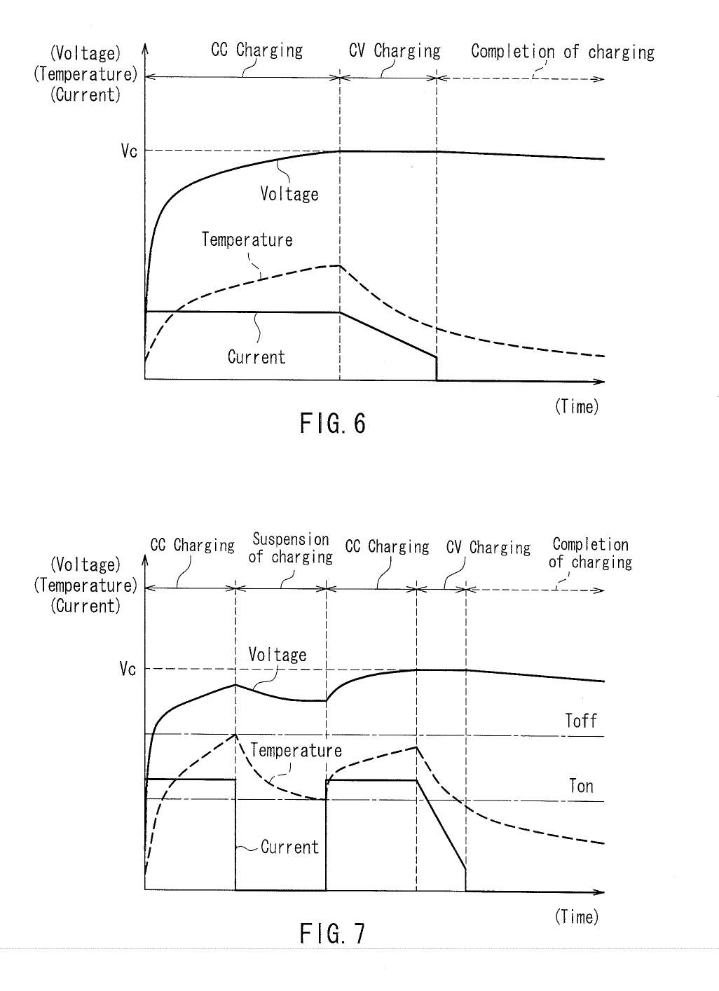

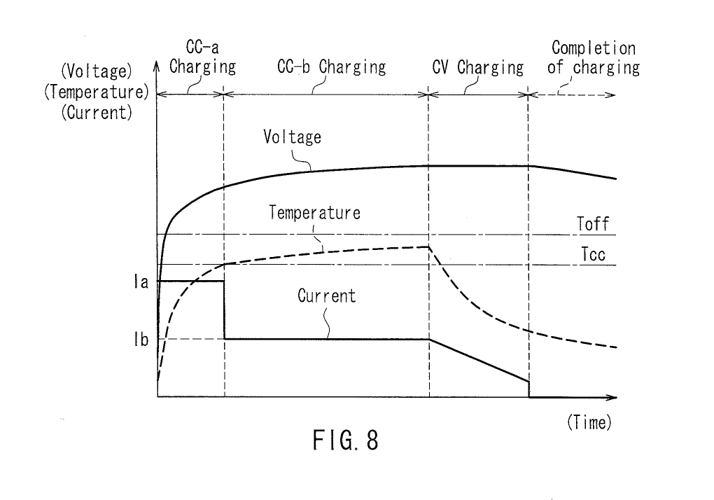

The Si-containing lithium ion secondary battery exhibits the heat generation characteristics as shown in FIG. 1. In FIG. 1, the horizontal axis represents time, and the vertical axis represents current, the SOC (state of charge), and temperature. The SOC refers to a ratio of a charge amount with respect to battery capacity. The characteristics exhibit a change in temperature of a battery (heat generation characteristics) involved in the CCCV charging with charging current being controlled in the same way as in the conventional example shown in FIG. 6.

According to the heat generation characteristics, when the temperature of a battery rises due to the heat generation during the CC charging with charging current being controlled to be constant, a temperature rise gradient is steep in an initial charging period, and after the charging is performed for a short period of time, the temperature rise gradient becomes gentle. Thus, when the steep temperature rise gradient changes to the gentle temperature rise gradient, a transition point Ta of the temperature rise gradient is recognized. With timing at which the transition point Tₐ appears after the start of the charging being a border, a former period of the CC charging is described as a T1 period (charging time t_{T1}), and a latter period of the CC charging is described as a T2 period (charging time t_{T2}).

The transition point Ta of the temperature rise gradient appears in the vicinity of the SOC of 10% as the characteristics common to Si-containing lithium ion secondary batteries. That is, even when the CC charging is performed at a condition of various SOCs, a transition point Ta appears in the vicinity of the SOC of 10%. Therefore, the time required for the transition point Ta to appear after the start of the charging depends upon the SOC when the charging starts. If the charging is started from a condition of a high SOC, a period during which the temperature rise gradient is steep becomes short, compared with the case of starting the charging from a condition of a low SOC. There also is a case where the temperature rise gradient becomes gentle immediately after the start of the charging.

As described above, two regions: the T1 period and the T2 period are present in a region of the CC charging, and the features of each period are as follows.
(1) Relationship in charging time between respective periods t_{T1} (charging time in T1 period)<t_{T2} (charging time in T2 period)
(2) Relationship in charging amount between respective periods t_{T1}*I_{q}<t_{T2}*I_{q} (I_{q} is charging current)
(3) Relationship in temperature gradient between respective periods ΔT1 (T1 period temperature gradient)>ΔT2 (T2 period temperature gradient)
(4) Relationship in temperature rise amount between respective periods δT1 (T1 period temperature rise amount)>δT2 (T2 period temperature rise amount)
(5) Total amount of heat generation involved in CC charging period=δT1+δT2

As described above, the Si-containing lithium ion secondary battery generates heat greatly in a short period of time in the T1 period, and the heat generation in the T2 period is suppressed compared with that in the T1 period or equivalent thereto. Thus, in order to suppress the total amount of the heat generation in the CC charging period, it is effective to suppress the temperature rise in the T1 period. Considering this, the charging method of the embodiments according to the present invention described later has a feature that the charging is performed at small current in a CC charging region corresponding to the T1 period, and the charging is performed at large current in the same way as in the conventional example in a CC charging region corresponding to the T2 period. Further, the completion period of the T2 period can be extended to a region in which the SOC exceeds 80%.

Hereinafter, the embodiments according to the present invention are described with reference to the drawings.

### Embodiment 1

A method for charging a lithium ion secondary battery according to Embodiment 1 of the present invention is described with reference to FIG. 2. In FIG. 2, the horizontal axis represents time, and the vertical axis represents current, the SOC, and temperature.

This charging method basically belongs to the CCCV charging method. Specifically, the CC charging is performed up to a predetermined set voltage V_{c} (not shown). After the set voltage V_{c} has reached (t_{cv}), the CC charging is switched to CV charging, and the CV charging is performed at the charging current being reduced so as to keep the set voltage. At a time t_{f} when the charging current has reached a set value I_{f}, the CV charging is stopped, whereby the charging is completed.

The present embodiment is characterized in a process of the CC charging, and as shown in FIG. 2, with the elapsed timing of the changeover time tₛ after the start of the charging being a border, the CC1 charging is performed in an initial period of the CC charging and the CC1 charging is switched to CC2 charging in a latter period of the CC charging. That is, in the CC1 charging from the start of the charging to the elapse of the changeover time tₛ, the charging is performed so as to keep a smaller first current value I₁. In the CC2 charging after the changeover time tₛ has elapsed, the charging is performed so as to keep a second current value I₂ larger than the first current value. The shift to the CV charging and the subsequent operation are the same as those of the conventional CCCV charging.

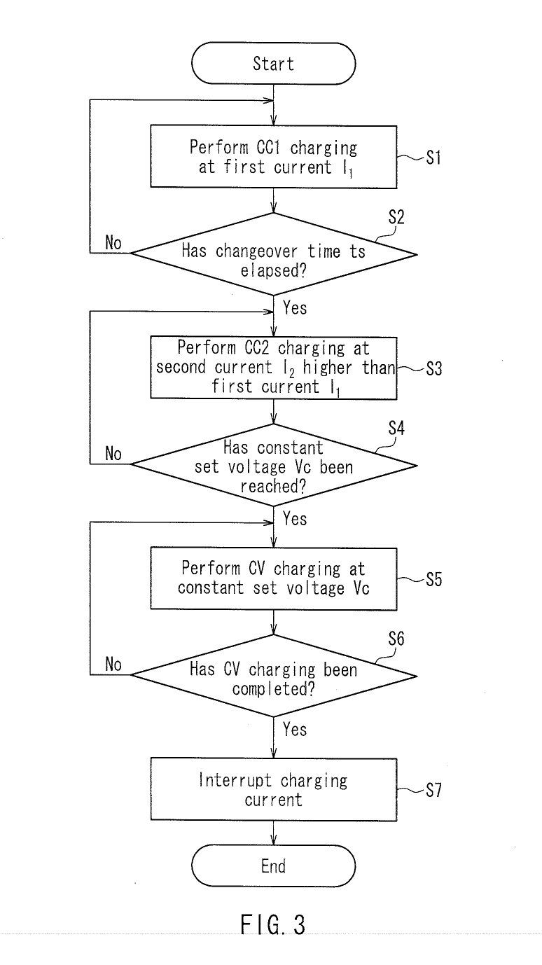

FIG. 3 shows a procedure of an operation in the above-mentioned charging method. When the charging starts, first, while the CC1 charging is performed at the first current value I₁ (Step S1), it is determined whether or not the changeover time tₛ has elapsed (Step S2). When the changeover time tₛ has elapsed (YES in Step S2), the process proceeds to Step S3, and the CC2 charging is performed at the second current value I₂ larger than the first current value. Along with this, it is determined whether or not the set voltage V_{c} has been reached (Step S4). When the set voltage V_{c} has been reached (Yes in Step S4), the CC2 charging is switched to the CV charging, and the charging is performed with the charging current being reduced so as to keep the set voltage V_{c} (Step S5). Along with this, it is determined whether or not the CV charging has been completed based on whether or not the charging current has reached the set value I_{f} (Step S6). When the CV charging has been completed (Yes in Step S6), the process proceeds to Step S7 to interrupt the charging current, whereby the charging is completed.

The changeover time tₛ in the above-mentioned charging method is basically set as follows. First, in advance, with respect to a lithium ion secondary battery having the same specification as that of a charging target, the charging is started from a condition of the SOC of 0% and a charging time t_{T} corresponding to timing at which the transition point Tₐ of the temperature rise gradient appears is measured. As described later, it is not necessary to detect directly the appearance of the transition point Tₐ when measuring the charging time t_{T}. In short, the charging time t_{T} only needs to be measured based on an event corresponding to the timing at which the transition point Tₐ appears. If the changeover time tₛ is set so as to correspond to the measured charging time t_{T}, the changeover time tₛ set in the vicinity of timing at which the transition point Tₐ appears. Accordingly, the CC1 charging can be switched to the CC2 charging in the vicinity of the transition point Tₐ of the temperature rise gradient.

In the present embodiment, one setting example of the changeover time tₛ corresponding to the charging time t_{T} is described. Considering that the changeover time tₛ peculiar to the present embodiment, the changeover time tₛ described as changeover time tₛ₁. First, in a lithium ion secondary battery having the same specification as that of a charging target, charging time t_{T10} from time when charging is started from a condition of the SOC of 0% to time when the SOC reaches 10% is measured in advance to be used as the charging time t_{T}.

As described above, the transition point Tₐ of the temperature rise gradient appears in the vicinity of the SOC of 10%. Therefore, if the changeover time tₛ₁ is set so as to correspond to the charging time t_{T10}, the changeover time tₛ₁ is set in the vicinity of timing at which the transition point Tₐ appears. Thus, the CC1 charging can be switched to the CC2 charging in the vicinity of the transition point Tₐ of the temperature rise gradient.

As a result, the CC1 charging is performed at the smaller first current value I₁ in a region substantially corresponding to the T1 period having a large temperature rise gradient, and the CC2 charging is performed at the larger second current value I₂ in a region substantially corresponding to the T2 period having a small temperature rise gradient. Thus, the charging can be performed efficiently while the heat generation is suppressed to minimize the temperature rise, and the time required for the charging can be shortened. In particular, if the CC charging is designed so as to be performed up to the SOC of 80%, the time required for charging can be shortened remarkably.

The reason that the above-mentioned effect can be obtained is as follows. Specifically, the transition point Tₐ of the temperature rise gradient appears in the vicinity of the SOC of 10%, and hence, a ratio of the T1 period occupying the CC charging period is small, and the temperature rise gradient is sufficiently small in the T2 period. Therefore, even when the charging current is reduced during a period corresponding to the T1 period, there is little influence on the speed of the entire charging. On the other hand, the heat generation is large in the T1 period, and hence, the effect of suppressing the temperature rise by reducing the charging current is large. Further, temperature rises less during a period corresponding to the T2 period having a small temperature rise gradient. Therefore, even when the CC2 charging is performed at large current, the temperature rise is suppressed, and the charging efficiency is enhanced. Thus, throughout the entire period of the CC charging, both suppression of the temperature rise and the high-speed charging can be satisfied.

As is understood from the reason that the above-mentioned effect can be obtained in the present embodiment, even if the changeover time tₛ₁ is set to be shifted from the charging time t_{T10} to some degree, a sufficient effect or a reasonable effect can be actually obtained when the CC1 charging controlled with the smaller first current value I₁ is included in the initial charging period. It should be noted that, according to the result of the study based on an experiment, the changeover time tₛ₁ is desirably set in a range of t_{T10}≦tₛ₁≦(t_{T10}×1.2) based on the charging time t_{T10}. That is, a desirable permissible range for obtaining the above-mentioned effect falls in a range of the time equivalent to the charging time t_{T10} to the time longer by 20% than the charging time t_{T10}.

Even when the changeover time tₛ₁ is set as described above, the changeover time tₛ₁ is not always matched with the timing at which the transition point Tₐ of the temperature rise gradient appears after the start of the charging. That is, as described above, the charging amount, or the charging time (t_{T1}) to be required before the transition point Tₐ appears various depending upon the SOC at the start of the charging. In contrast, as the charging time t_{T10} for setting the changeover time tₛ₁, a measurement result obtained in the case of starting the charging from a condition of the SOC of 0% is used. Therefore, some shift occurs between the changeover time tₛ₁ and the timing at which the transition point Tₐ appears.

It should be noted that the charging time (t_{T1}) to be required before the transition point Tₐ appears may become shorter depending upon the SOC at the start of the charging but does not becomes longer. Thus, by setting the changeover time tₛ₁ in a range of t_{T10}≦tₛ₁≦(t_{T10}×1.2), as described above, the CC1 charging is performed at the smaller first current value I₁ without fail in a region corresponding to the T1 period having a large temperature rise gradient, and thus, the temperature rise can be suppressed reliably.

On the other hand, the CC1 charging may be extended to a region corresponding to the T2 period. This is disadvantageous for shortening the time for the CC charging because the charging period with smaller current is long. However, a ratio of the charging time t_{T10} to be a basis of the changeover time tₛ₁, occupying the CC charging, is small, and hence, influence of shortening of the charging time is small if the period of the CC1 charging is up to +20% as described above. Accordingly, contribution to efficient charging, avoiding temperature rise, can be obtained sufficiently. This effect is obtained reasonably irrespective of the other conditions, if the changeover time tₛ₁ is set in the above range with respect to the charging time t_{T10}.

For example, with respect to a comparison between charging at a 2C rate and charging at a 1C rate in the period of the CC1 charging, temperature rise will be as follows. Herein, it should be noted that although the transition point Tₐ of the temperature rise gradient highly depends upon the addition amount of Si, a substantial change in the transition point Tₐ caused by the SOC is not found. Therefore, the charging time up to the SOC of 10% changes substantially in proportion with the SOC.

The Si-containing lithium ion secondary battery can be set, for example, so that the transition point Tₐ of the temperature rise gradient appears at the SOC of about 10% with a 2C rate of a total amount of charge. In this case, when the Si-containing lithium ion secondary battery is charged at a 2C rate, the charging time before the SOC reaches 10% is 3 minutes, and the temperature rise during that time is about 15° C. On the other hand, when the Si-containing lithium ion secondary battery is charged at a 1C rate, the charging time before the SOC reaches 10% is 6 minutes, and the temperature rise during that time is about 7° C. Thus, even when current of the CC1 charging is reduced, the charging time only needs to be extended by about 3 minutes, and the temperature rise during the CC1 charging can be suppressed to about a half.

Further, when the Si-containing lithium ion secondary battery is charged at a 2C rate, the temperature rise during the period of CC2 charging is about 10° C. Thus, when the CC1 charging (1C) and the CC2 charging (2C) are combined as shown in FIG. 2, a total temperature rise value during the period of the CC charging is about 17° C. A total temperature rise when the CC charging is performed at a 2C rate continuously is about 25° C. Thus, it is understood that the temperature rise can be suppressed by combining the CC1 charging and the CC2 charging. Consequently, it becomes easy to enhance a charging speed with larger current during the CC2 charging.

Further, if the first current value I₁ is set to a value smaller than the second current value I₂ in a range applicable to the CC charging according to the well-known CCCV charging method, a practical effect can be obtained reasonably. It is preferred practically to set the first current value I₁ in a range of a 0.7C to 0.8C level. This is because the effect of suppressing temperature rise is obtained sufficiently, and influence on an increase in a charging speed is small. It is particularly effective for increasing a charging speed to set the second current value I₂ at 1.5C or more.

By replacing the charging time t_{T10} in the above-mentioned embodiment with the general charging time t_{T} corresponding to the timing at which the transition point Tₐ of the temperature rise gradient appears, it can be stated that more general changeover time tₛ set in a range of t_{T}≦tₛ≦(t_{T}×1.2).

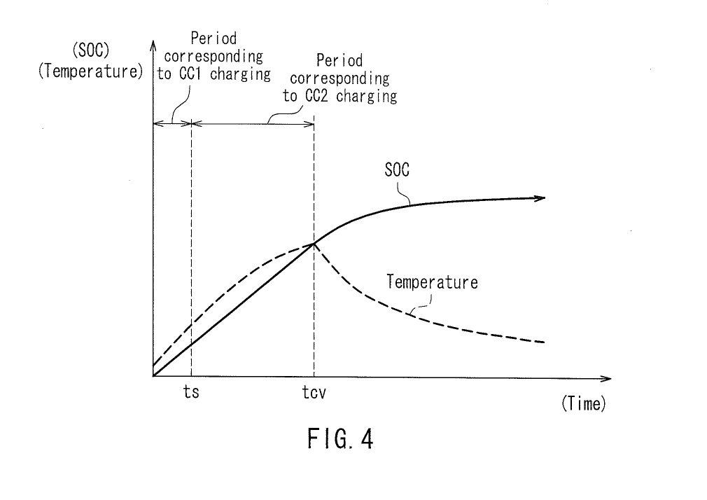

FIG. 4 shows characteristics of a conventional lithium ion secondary battery to which the charging method of the present embodiment is not applicable. As shown in FIG. 4, in the case of the conventional battery, the temperature rises at a gentle gradient as a whole in a region of the CC charging, and hence, the effect obtained by the above-mentioned charging method cannot be expected. That is, there is no transition point of a temperature rise gradient. Therefore, even when the charging is performed at suppressed current corresponding to the CC1 charging in an initial charging stage before the charging time t_{T10} when the SOC reaches 10%, the heat generation during charging corresponding to the later CC2 charging is large, and hence, it cannot be expected to suppress the total heat generation amount greatly. Accordingly, it is difficult to shorten the charging time with large current.

### Embodiment 2

A method for charging a lithium ion secondary battery of Embodiment 2 according to the present invention is substantially the same as that of Embodiment 1. In the present embodiment, the changeover time tₛ₁ in the case of Embodiment 1 is replaced with changeover time tₛ₂. Thus, the contents shown in FIGS. 1 and 2 are common to the present embodiment except for the changeover time tₛ₁, and the effects to be obtained are the same as those of Embodiment 1.

The changeover time tₛ₂ in the present embodiment is set as follows. Specifically, in advance, with respect to a lithium ion secondary battery having the same specification as that of a charging target, the charging is started from a condition of the SOC of 0% and a charging time t_{TA} before the transition point Tₐ of the temperature rise gradient is detected is measured.

If changeover time tₛ₂ is set so as to correspond to the charging time t_{TA}, the changeover time tₛ₂ is set at timing when the transition point Tₐ appears. Thus, the CC1 charging can be switched to the CC2 charging at the transition point Tₐ of a temperature rise gradient.

Embodiment 2 is different from Embodiment 1 in that the changeover time tₛ₁ is set so as to indirectly correspond to the transition point Tₐ of a temperature rise gradient through use of a point of time when the SOC reaches 10%, whereas the changeover time tₛ₂ is set so as to directly correspond to the charging time t_{TA} before the transition point Tₐ of a temperature rise gradient is detected. Accordingly, the CC1 charging can be switched to the CC2 charging at more precise timing.

As a result, in the same way as in Embodiment 1, the CC1 charging is performed at the smaller first current value I₁ in a region corresponding to the T1 period having a large temperature rise gradient, and the CC2 charging is performed at the larger second current value I₂ in a region corresponding to the T2 period having a small temperature rise gradient. As a result, charging can be performed efficiently while heat generation is suppressed to minimize temperature rise, and time required for charging can be shortened.

Even if the changeover time t_{S2} is set to be shifted from the charging time t_{TA} to some degree, when the CC1 charging controlled by the smaller first current value I₁ is included in an initial charging period, sufficient effects or corresponding effects can be obtained practically. It is desired that the changeover time tₛ₂ be set in a range of t_{TA}≦tₛ₂≦(t_{TA}×1.2) based on the charging time t_{TA} in the same way as in Embodiment 1. That is, the time equivalent to the charging time t_{TA} to the time that is longer by 20% than the charging time t_{TA} is a desirable permissible range for obtaining the above-mentioned effects.

It should be noted, similarly to the Embodiment 1, that, in actual charging, even when the changeover time tₛ₂ is set as described above, the changeover time tₛ₂ is not always matched with timing at which the transition point Tₐ of a temperature rise gradient appears after start of the charging. Practically, the SOC at a time of start of charging is not constant, and hence, the charging time (t_{T1}) does not become constant, either. Nevertheless, as the charging time t_{TA} for setting the changeover time tₛ₂, a measurement result in the case of starting the charging from a condition of the SOC of 0% is used. Therefore, the changeover time tₛ₂ may be shifted from the timing at which the transition point Tₐ appears to some degree.

If the changeover time tₛ₂ is set in a range of t_{TA}≦tₛ₂≦(t_{TA}×1.2) as described above, the CC1 charging is performed at the smaller first current value I₁ without failure in a region corresponding to the T1 period having a large temperature rise gradient, and the temperature rise is suppressed reliably. Further, the charging time t_{TA} to be a basis of the changeover time tₛ₂ has a small ratio occupying the CC charging period, and hence, there is small influence of shortening the charging time, as long as the CC1 charging period is up to +20% as described above. Thus, contribution to efficient charging can be obtained sufficiently while avoiding the temperature rise. This effect is obtained reasonably irrespective of the other conditions, if the changeover time tₛ₂ is set in the above-mentioned range with respect to the charging time t_{TA}.

### Embodiment 3

A method for charging a lithium ion secondary battery according to Embodiment 3 of the present invention is substantially similar to that of Embodiment 1. The contents shown in FIGS. 1 and 2 are common to those of the present embodiment and are based on the same principle as that of Embodiment 1. The present embodiment includes a step of determining a charge state of a lithium ion secondary battery before start of the charging, which is the feature different from that of Embodiment 1. Consequently, the effect of shortening the charging time is further enhanced.

Determination of a charge state of a lithium ion secondary battery is performed so as to detect whether the charge state is before the above-mentioned transition point Tₐ of a temperature rise gradient of the battery during the CC charging or the charge state exceeds the transition point Tₐ. Then, if the charge state is before the transition point Tₐ, the CC charging is performed at a first current value until the changeover time tₛ elapses after start of charging, and after the changeover time tₛ elapses, the CC charging is performed at a second current value. On the other hand, if the charge state exceeds the transition point Tₐ, the CC charging is performed at a second current value.

Determination of a charge state for detecting whether the charge state exceeds the transition point Tₐ or not can be performed based on, for example, the SOC of 10%. That is, when the SOC is equal to or less than 10%, it is determined that the charge state is before the transition point Tₐ, and when the SOC exceeds 10%, it is determined that the charge state exceeds the transition point Tₐ. The SOC of 10% substantially corresponds to the transition point Tₐ as described above.

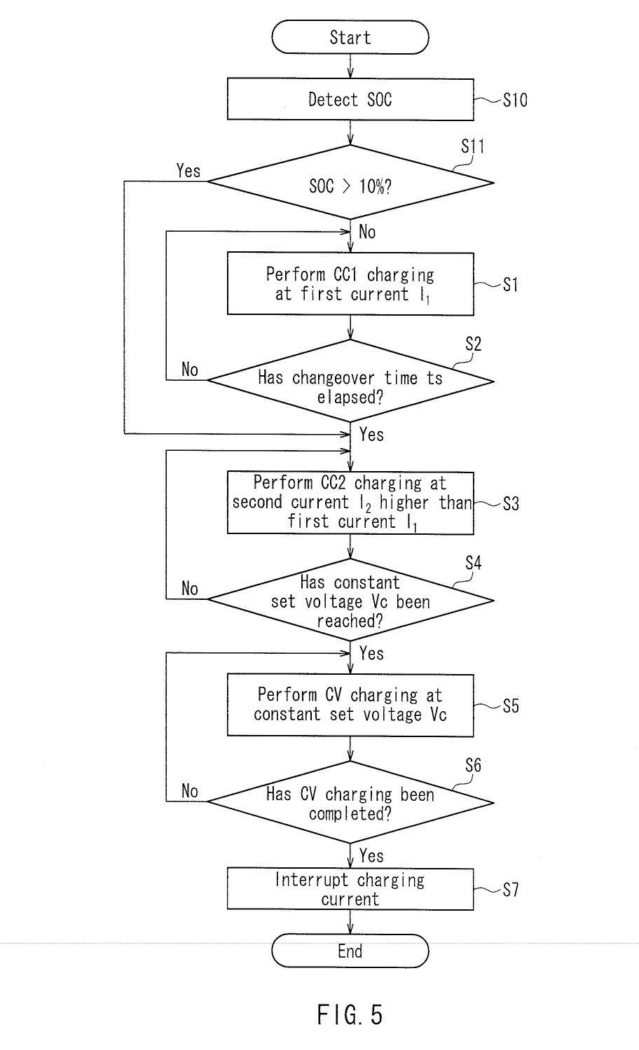

FIG. 5 is a flowchart showing a procedure of an operation of a charging method of the present embodiment in the case of using the SOC for determining a charge state.

As shown in FIG. 5, when charging starts, the SOC is first detected (Step S10). Then, it is determined whether the detected SOC exceeds 10% or not (Step S11). When the SOC exceeds 10% (Yes in Step S11), the process proceeds to Step S3, and the CC2 charging is started at the second current value I₂. The subsequent steps are similar to those of Embodiment 1.

On the other hand, when the SOC is equal to or less than 10% (No in Step S11), the process proceeds to Step S1, and the CC1 charging is started at the first current value I₁. The subsequent steps are similar to those of Embodiment 1.

According to the charging method of the present embodiment, when charging is started from a state in which the SOC exceeds 10%, the CC1 charging with the first current value I₁ is omitted, and hence, the effect of shortening time required for charging can be enhanced.

The step of determining a charge state before start of charging also is applicable to the method using the changeover time tₛ₂ in Embodiment 2.

### INDUSTRIAL APPLICABILITY

A method for charging a lithium ion secondary battery of the present invention enables charging to be performed efficiently while suppressing temperature rise, and hence, is useful for charging lithium ion secondary batteries to be used for various applications such as mobile equipment.

1. A method for charging a lithium ion secondary battery by constant current constant voltage (CCCV) charging, comprising: a step of performing constant current (CC) charging up to a predetermined set voltage; and a step of switching to constant voltage (CV) charging after the set voltage is reached, thus performing charging while reducing charging current so as to keep the set voltage, wherein the lithium ion secondary battery is composed using a negative electrode material containing Si, thereby having characteristics such that, during a period of the CC charging, a transition point Tₐ appears in a temperature rise gradient when temperature of the battery rises along with progression of the charging, and with the transition point Tₐ being a border, a temperature rise gradient in an initial T1 period is steeper than a temperature rise gradient in a T2 period following the T1 period, changeover time tₛ is set in a range of t_{T}≦tₛ≦(t_{T}×1.2), based on charging time t_{T} corresponding to timing at which the transition point Tₐ appears after start of the CC charging from a condition of the SOC of 0%, obtained by measurement in advance, and during a period of the CC charging, the CC charging is performed at a first current value until the changeover time tₛ elapses after start of the charging, and after the changeover time tₛ elapses, the CC charging is performed at a second current value larger than the first current value.

2. A method for charging a lithium ion secondary battery by constant current constant voltage (CCCV) charging, comprising: a step of performing constant current (CC) charging up to a predetermined set voltage; and a step of switching to constant voltage (CV) charging after the set voltage is reached, thus performing charging while reducing charging current so as to keep the set voltage, wherein the lithium ion secondary battery is composed using a negative electrode material containing Si, thereby having characteristics such that, during a period of the CC charging, a transition point Tₐ appears in a temperature rise gradient when temperature of the battery rises along with progression of the charging, and with the transition point Tₐ being a border, a temperature rise gradient in an initial T1 period is steeper than a temperature rise gradient in a T2 period following the T1 period, changeover time tₛ is set in a range of t_{T}≦tₛ≦(t_{T}×1.2), based on charging time t_{T} corresponding to timing at which the transition point Tₐ appears after start of the CC charging from a condition of the SOC of 0%, obtained by measurement in advance, a charge state of the lithium ion secondary battery is determined before start of the charging, and during a period of the CC charging, when the charge state is before the transition point Tₐ, the CC charging is performed at a first current value until the changeover time tₛ elapses from start of the charging, and after the changeover time tₛ elapses, the CC charging is performed at a second current value larger than the first current value, and when the charge state exceeds the transition point Tₐ, the CC charging is performed at a second current value larger than the first current value.

3. The method for charging a lithium ion secondary battery according to claim 2, wherein the SOC of the lithium ion secondary battery is measured before start of the charging, when the SOC is 10% or less, it is determined that the charge state is before the transition point Tₐ, and when the SOC exceeds 10%, it is determined that the charge state exceeds the transition point Tₐ.

4. The method for charging a lithium ion secondary battery according to claim 1, wherein the charging time t_{T} is defined as charging time t_{T10} that elapses from a start of the charging at a condition of the SOC of 0% to time when the SOC reaches 10%, and changeover time tₛ₁ representing the changeover time tₛ is set in a range of t_{T10}≦tₛ₁≦(t_{T10}×1.2).

5. The method for charging a lithium ion secondary battery according to claim 1, wherein the charging time t_{T} is defined as a charging time t_{TA} that elapses from a start of the charging at a condition of the SOC of 0% to time when the transition point of a temperature rise gradient is detected, and changeover time tₛ₂ representing the changeover time tₛ is set in a range of t_{TA}≦tₛ₂≦(t_{TA}×1.2).

6. The method for charging a lithium ion secondary battery according to claim 1, wherein when 1C is defined as a current value at which the lithium ion secondary battery that is fully charged is discharged within one hour, the first current value is set in a range of 0.7 to 0.8C.

7. The method for charging a lithium ion secondary battery according to claim 1, wherein the second current value is set to 1.5C or more.

8. The method for charging a lithium ion secondary battery according to claim 1, wherein the SOC at completion of the T2 period is set so as to exceed 80%.

9. The method for charging a lithium ion secondary battery according to claim 1, wherein the lithium ion secondary battery is composed using a composite material (SiOₓ) having a structure in which ultra-fine particles of Si are dispersed in SiO₂ as the negative electrode material.

10. The method for charging a lithium ion secondary battery according to claim 9, wherein the composite material (SiOₓ) is formed of a core containing a material in which an atomic ratio x of oxygen with respect to silicon is 0.5≦x≦1.5, and a covering layer of carbon covering a surface of the core.

11. The method for charging a lithium ion secondary battery according to claim 2, wherein the charging time t_{T} is defined as charging time t_{T10} that elapses from a start of the charging at a condition of the SOC of 0% to time when the SOC reaches 10%, and changeover time tₛ₁ representing the changeover time tₛ is set in a range of t_{T10}≦tₛ₁≦(t_{T10}×1.2).

12. The method for charging a lithium ion secondary battery according to claim 2, wherein the charging time t_{T} is defined as a charging time t_{TA} that elapses from a start of the charging at a condition of the SOC of 0% to time when the transition point of a temperature rise gradient is detected, and changeover time tₛ₂ representing the changeover time tₛ is set in a range of t_{TA}≦tₛ₂≦(t_{TA}×1.2).

13. The method for charging a lithium ion secondary battery according to claim 2, wherein when 1C is defined as a current value at which the lithium ion secondary battery that is fully charged is discharged within one hour, the first current value is set in a range of 0.7 to 0.8C.

14. The method for charging a lithium ion secondary battery according to claim 2, wherein the second current value is set to 1.5C or more.

15. The method for charging a lithium ion secondary battery according to claim 2, wherein the SOC at completion of the T2 period is set so as to exceed 80%.

16. The method for charging a lithium ion secondary battery according to claim 2, wherein the lithium ion secondary battery is composed using a composite material (SiOₓ) having a structure in which ultra-fine particles of Si are dispersed in SiO₂ as the negative electrode material.

17. The method for charging a lithium ion secondary battery according to claim 16, wherein the composite material (SiOₓ) is formed of a core containing a material in which an atomic ratio x of oxygen with respect to silicon is 0.5≦x≦1.5, and a covering layer of carbon covering a surface of the core.
